(19) United States
(12) Patent Application Publication
(10) Pub. No.: US 2025/0291187 A1
(43) Pub. Date: Sep. 18, 2025

(54) INJECTION-MOLDED AUGUMENTED REALITY PUSH-PULL LENS AND METHOD OF DETECTING THE POSITION OF THE WAVEGUIDE INSIDE A POLYCARBONATE SUBSTRATE

(71) Applicant: Applied Materials, Inc., Santa Clara, CA (US)

(72) Inventor: Davide COLLA, Treviso (IT)

(21) Appl. No.: 19/057,500

(22) Filed: Feb. 19, 2025

Related U.S. Application Data
(60) Provisional application No. 63/566,049, filed on Mar. 15, 2024.

(51) Int. Cl. G02B 27/01

(52) U.S. Cl. CPC G02B 27/0172; G02B 2027/0123

(57) ABSTRACT

Embodiments of the present disclosure relate to an injection-molded push pull lens, and related components and methods for manufacturing. In one or more embodiments, an optical device includes a waveguide. The waveguide includes a first surface and a second surface opposing the first surface. The first surface and the second surface are connected by an edge. One or more gratings are disposed over the first surface or the second surface. The optical device further includes a thermoplastic lens surrounding the first surface, second surface, and the edge. The thermoplastic lens comprises a first lens surface disposed over the first surface and a second lens surface disposed over the second surface.

### CROSS-REFERENCE TO RELATED APPLICATIONS

This application claims priority to U.S. Provisional Patent Application Ser. No. 63/566,049, filed Mar. 15, 2024 the contents of which are incorporated herein by reference.

### BACKGROUND

### Field

Embodiments of the present disclosure relate to optical devices having a waveguide and thermoplastic lens and method of fabricating optical devices.

### Description of the Related Art

Virtual reality is generally considered to be a computer-generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment. Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

Accordingly, what is needed in the art are optical devices having a waveguide and thermoplastic lens and method of fabricating optical devices.

### SUMMARY

In one or more embodiments, an optical device includes a waveguide. The waveguide includes a first surface and a second surface opposing the first surface. The first surface and the second surface are connected by an edge. One or more gratings are disposed over the first surface or the second surface. The optical device further includes a thermoplastic lens surrounding the first surface, second surface, and the edge. The thermoplastic lens comprises a first lens surface disposed over the first surface and a second lens surface disposed over the second surface.

In one or more embodiments, a chamber includes a chamber body, an extruder, and one or more tapered supports. The one or more tapered supports are configured to support a waveguide. The waveguide includes one or more gratings. The tapered supports are configured to contact the waveguide around the gratings. The chamber further includes an upper channel, configured to be positioned above the waveguide. The chamber further includes a lower channel configured to be positioned below a waveguide.

In one or more embodiments, a method of forming an optical device includes forming a thermoplastic block around a waveguide. The waveguide includes a first surface and a second surface opposing the first surface. The first surface and the second surface are connected by an edge. One or more gratings are disposed over the first surface or the second surface. The method further includes milling the thermoplastic block to reduce a second lens surface to form a thermoplastic lens. The thermoplastic lens surrounding the first surface, second surface, and the edge.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a perspective, frontal view of a waveguide according to one or more embodiments described herein.

FIG. 2 is a schematic, cross sectional view of an optical device, according to one or more embodiments described herein.

FIG. 3 is a schematic, cross sectional view of an optical device, according to one or more embodiments described herein.

FIG. 4 is a schematic, cross sectional view of a portion of an optical device, according to one or more embodiments described herein.

FIG. 5 is a flow diagram of a method of forming an optical device, according to one or more embodiments described herein.

FIG. 6 is a schematic, cross-sectional view of a mold chamber, according to one or more embodiments described herein.

FIG. 7 is a schematic view of a thermoplastic block during a measuring operation, according to one or more embodiments described herein.

FIG. 8 is a schematic view of a thermoplastic block after an engraving operation, according to one or more embodiments described herein described herein.

FIG. 9 is a schematic view of a thermoplastic block during a milling operation, according to one or more embodiments described herein.

FIG. 10 is a schematic, isometric view of an optical device, according to one or more embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure relate to optical devices having a waveguide and thermoplastic lens and method of fabricating optical devices.

The disclosure contemplates that terms such as “couples,” “coupling,” “couple,” and “coupled” may include but are not limited to bonding, embedding, welding, fusing, melting together, interference fitting, and/or fastening such as by using bolts, threaded connections, pins, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links, blocks, and/or frames.

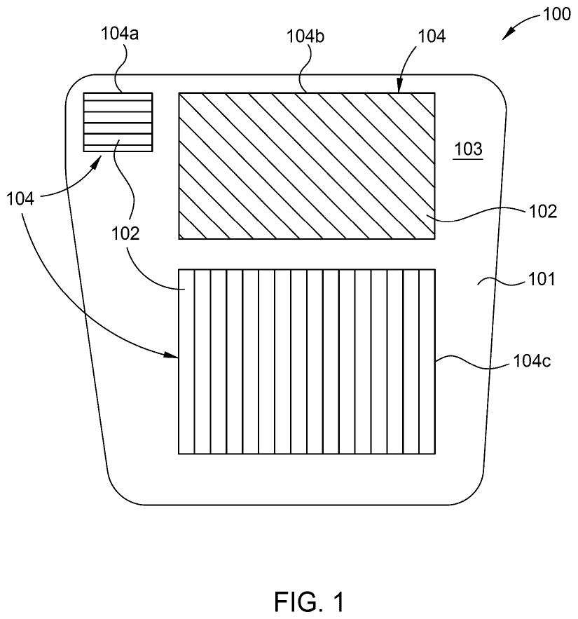

FIG. 1 is a perspective, frontal view of a waveguide 100, according to one or more embodiments. It is to be understood that the waveguide 100 described herein is an exemplary waveguide and that other waveguides may be used with or modified to accomplish aspects of the present disclosure. The waveguide 100 includes a plurality of structures 102. The structures 102 may be disposed over, under, or on a first surface 103 of a substrate 101, or disposed in the substrate 101. The structures 102 are nanostructures have a sub-micron critical dimension, e.g., a width less than 1 micrometer. Regions of the structures 102 correspond to one or more gratings 104. Any of the grating 104 may be disposed over, under, or on the first surface 103 or over, under, or on a second surface 105. In one embodiment, which can be combined with other embodiments described herein, the waveguide 100 includes at least a first grating 104a corresponding to an input coupling grating (“Incoupler”) and a third grating 104c corresponding to an output coupling grating (“Outcoupler”). In another embodiment, which can be combined with other embodiments described herein, the waveguide 100 further includes a second grating 104b. The second grating 104b corresponds to a pupil expansion grating (“Pupil Expander”) or a fold grating.

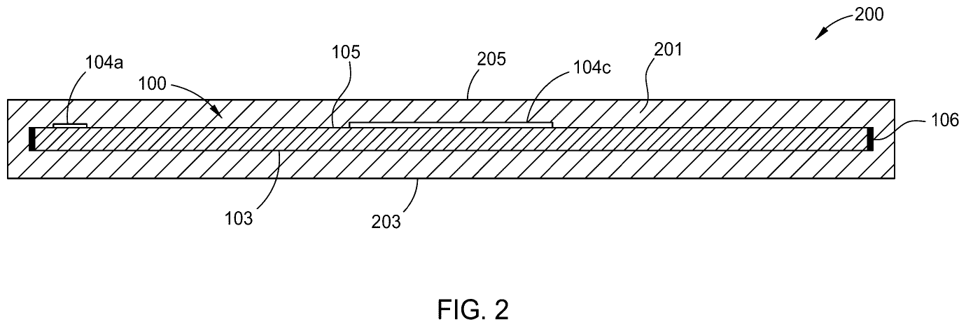

FIG. 2 is a schematic cross sectional view of an optical device 200, according to one or more embodiments. The waveguide 100 includes the first surface 103, a second surface 105, and one or more edges 106. The thermoplastic lens 201 surrounds the waveguide 100. The thermoplastic lens 201 includes a first lens surface 203 disposed over the first surface 103, and a second lens surface 205 disposed over the second surface 105. The first lens surface 203 is configured to be facing the eye of the user and is known as the eye-side lens. The second lens surface 205 is facing the opposite side of the first lens surface and is configured to be facing the outside world and is known as the world-side lens. The first grating 104a and the third grating 104c may be disposed over, under, or on the first surface 103 or over, under, or on a second surface 105. In some embodiments the first grating 104a and the third grating 104c are disposed on the same side. In some embodiments the first grating 104a and the third grating 104c are disposed on opposing sides.

The thermoplastic lens 201 is formed out of a thermoplastic material. In one or more embodiments the thermoplastic material is a polycarbonate material. In one or more embodiments the thermoplastic material is a polyallyl diglycol carbonate. The polyallyl diglycol carbonate may be allyl diglycol carbonate. The refractive index of the thermoplastic lens 201 is about 1.4 to about 1.7. In one or more embodiments the refractive index of the thermoplastic lens 201 is about 1.5 to 1.6. In one example, the refractive index of the thermoplastic lens 201 is 1.58. The refractive index of the waveguide 100 is about 1.5 to 2.1. In one example, the refractive index of the waveguide is 2.08. In one or more embodiments the one or more edges 106 are coated in a blackening ink. In one or more embodiments the one or more edges 106 are thermal-cured.

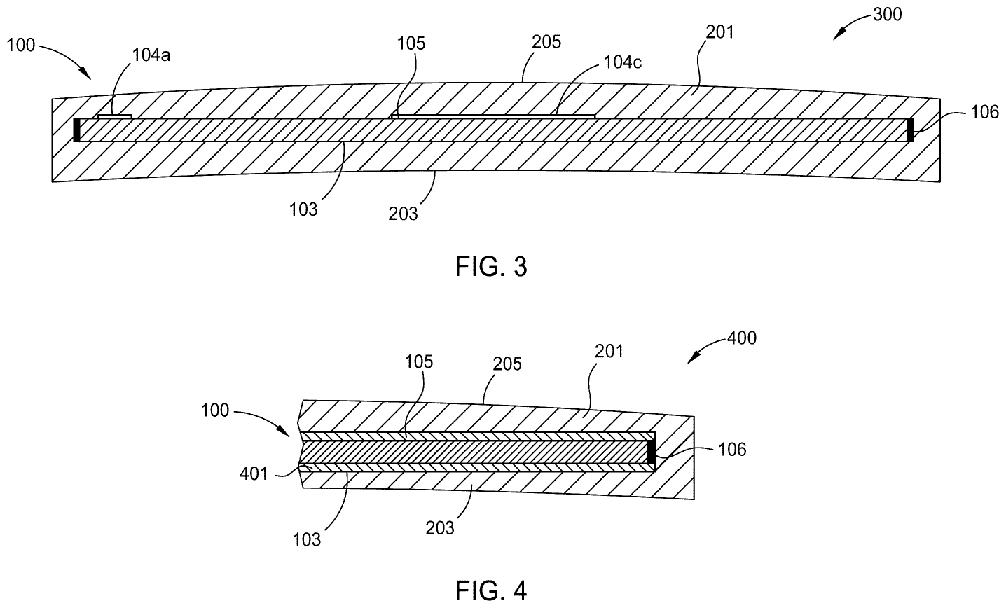

FIG. 3 is a schematic cross sectional view of an optical device 300, according to one or more embodiments. The optical device 300 is similar to the optical device 200 shown in FIG. 2, and includes one or more of the aspects, features, components, properties, and/or operations thereof.

The first lens surface 203 and the second lens surface 205 of the thermoplastic lens 201 of optical device 300 are curved. In one or more embodiments the first lens surface 203 is concave and the second lens surface 205 is convex. The curved surfaces alter the image of the light passing through the optical device 300 by bending the light beams, and cause the optical device 300 to have an ophthalmic correction that can be used in prescription eye glasses. The ophthalmic correction can be adjusted by changing the curvature of the first lens surface 203 and the second lens surface 205. In one or more embodiments, the first lens surface 203 has a negative diopter. In one or more embodiments, the second lens surface 205 has a positive diopter. The overall ophthalmic correction can be adjusted by adjusting the diopter of either the first lens surface 203 or the second lens surface 205. For example, the first lens surface may have an ophthalmic correction of −0.5 diopter. The second lens surface can have an ophthalmic correction of +1.5 diopter. Therefore the overall ophthalmic correction of the optical device 300 is +1.0 diopter. In one or more embodiments the second lens surface 205 has a fixed positive diopter of about +0.5 diopter. The first lens surface 203 may be customized in order to achieve the desired lens correction based on the ophthalmic prescription of the user. In one or more embodiments the correction of the first lens surface 203 is about-0.5 diopter to about −1.0 diopter.

In one or more embodiments the first lens surface 203 includes a light engine seat 304. The light engine seat is a flat surface positioned in line with the first grating 104a of the waveguide 100. The first grating 104a and the third grating 104c may be disposed over, under, or on the first surface 103 or over, under, or on a second surface 105. In some embodiments the first grating 104a and the third grating 104c are disposed on the same side. In some embodiments the first grating 104a and the third grating 104c are disposed on opposing sides. In one or more embodiments, the light engine seat 304 is machined into the first lens surface 203. The light engine seat 304 is configured allow a light engine to be directly coupled to the light engine seat 304, and allow the light engine to project an image into the first grating 104a. In one or more embodiments a prism (not shown) is coupled to the light engine seat 304, and the light engine is coupled to the prism. The prism is configured to direct the light beams from the light engine to the first grating 104a. In one or more embodiments the light engine is directly coupled to the light engine seat 304.

FIG. 4 is a schematic cross sectional view of a portion of the optical device 300, according to one or more embodiments.

In some embodiments, the optical device 300 includes an intermediate layer 401. In at least one embodiment, the intermediate layer 401 is disposed over the first surface 103 and the second surface 105 of the waveguide 100. The intermediate layer 401 does not cover the edge 106 of the waveguide 100. The edge 106 directly contacts the thermoplastic lens 201 surrounding the waveguide. The intermediate layer 401, in this embodiment, may only be disposed on the first surface 103 and the second surface 105. The intermediate layer is surrounded by the thermoplastic lens 201. The intermediate layer 401 works as cladding layer between the waveguide 100 and the thermoplastic lens 201. The intermediate layer 401 contains the light injected into the first grating 104a within the waveguide 100. In one or more embodiments the intermediate layer 401 is formed from aerogel.

The refractive index of the intermediate layer is about 1.0 to 1.1 such as a refractive index of 1.05. The intermediate layer can be formed from any material having a low refractive index. In some embodiments the intermediate layer is formed from an aerogel material. In some embodiments the intermediate layer is formed from silicon dioxide (SiO₂). In some embodiments the intermediate layer is formed from metal oxides and/or fluorine compounds having a low refractive index.

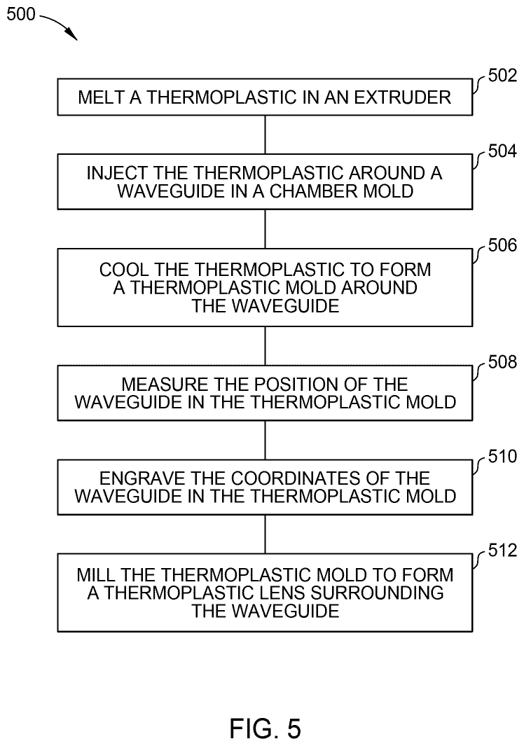

FIG. 5 is a schematic flow chart view of a method 500 of forming an optical device, according to one or more embodiments. The method 500 can be conducted in relation to any of the previously described optical devices 200, 300, 400 or other optical devices.

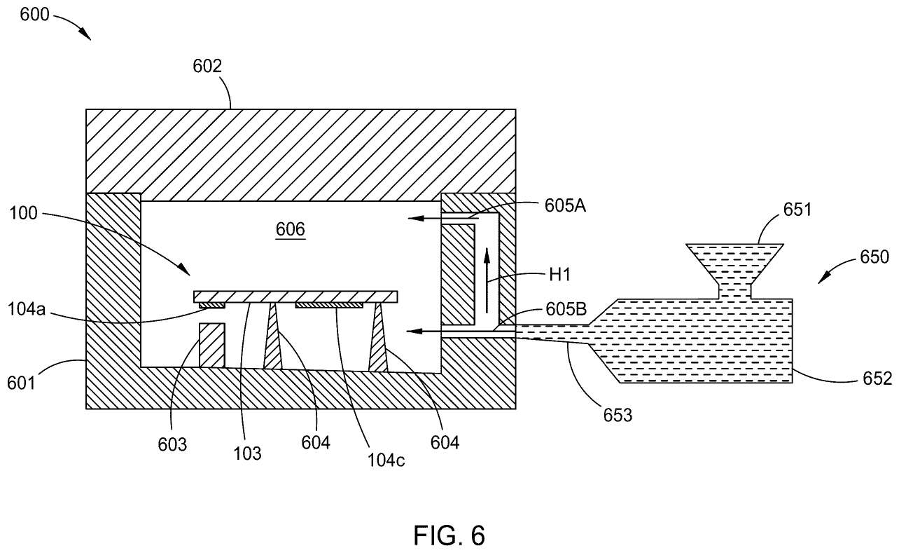

Prior to operation 502, a waveguide is disposed in a mold chamber 600 as shown in FIG. 6. FIG. 6 is a schematic, cross-sectional view of a mold chamber 600. The mold chamber 600 includes a chamber body 601 and a lid 602. The chamber body 601 is coupled to the lid 602 to define a mold volume 606. The chamber body 601 is thermo-regulated so that the temperature within the mold volume 606 can be controlled. In one or more embodiments the chamber body 601 includes one or more cooling channels in order for the chamber body 601 to be thermo-regulated. In one or more embodiments the chamber body 601 is formed from a steel alloy. The one or more cooling channels are bored into the chamber body 601. A cooling fluid is flowed through the one or more cooling channels in order to regulate the temperature of the chamber body 601. In one or more embodiments the cooling fluid is water. An upper channel 605A and a lower channel 605B are disposed in sidewalls of chamber body 601. The upper channel 605A is disposed above the lower channel 605B. The upper channel 605A and the lower channel 605B are fluidly connected to the extruder 650. One or more supports 604 are coupled to the bottom of the chamber body 601. The one or more supports 604 are configured to contact the first surface 103 between the first grating 104a and the third grating 104c. The one or more supports 604 contact the first surface 103 between the first grating 104a and the third grating 104c to support the waveguide without damaging the first grating 104a and the third grating 104c. The supports 604 have a height such that when the waveguide 100 is disposed in the mold volume 606 the first surface 103 is exposed to the lower channel 605B and the first surface 103 is exposed to the upper channel 605A. A mold protrusion 603 is coupled to the bottom of the chamber body 601. The mold protrusion 603 is configured to align with the first grating 104a with the waveguide 100 is in mold chamber 600. In one or more embodiments the mold protrusion 603 is formed of a thermo-conductive steel alloy. The mold protrusion helps cool the thermos-plastic hot-melt H1 by conducting the heat from the thermo-plastic hot melt H1 to the chamber body 601 in order to prevent the first grating 104a from being damaged by a thermoplastic hot-melt H1.

At operation 502, a thermoplastic material is melted in the extruder 650. The extruder 650 includes a hopper 651, a body 652, and a hot-melt channel 653. To melt the thermoplastic material, the thermoplastic material is inserted into the hopper 651 which delivers the thermoplastic material to the body 652. The thermoplastic material is then melted inside of the body 652. The thermoplastic material can include polycarbonate material in the form of granules or pellets. The granules or pellets are poured into the hopper 651. The granules or pellets are melted into liquid form inside the body 652.

At operation 504, as shown in FIG. 6, the thermoplastic material is injected into a chamber mold around a waveguide. A thermoplastic hot-melt H1 is injected from the hot-melt channel 653 of the extruder 650 into the mold chamber 600 through the upper channel 605A and lower channel 605B. In one or more embodiments the upper channel 605A and the lower channel 605B are thermo-insulated from the rest of the chamber body 601. The hot-melt H1 flows through the upper channel 605A and the lower channel 605B into the mold volume 606. When the hot-melt H1 reaches the mold volume 606 the hot-melt H1 is cooled by the chamber body 601 and the mold protrusion 603 to the desired temperature. The hot-melt H1 is cooled in order to prevent the blackening ink on the one or more edges 106 from getting damaged. In some embodiments the hot-melt is cooled to prevent the mirror coating disposed over the first grating 104a from getting damaged. In one or more embodiments the blackening ink coating disposed on the one or more edges 106 is thermal-cured so that the blackening ink is not damaged by the hot-melt H1. The rate at which the hot-melt H1 is injected can be controlled in order to control the rate at which the hot-melt H1 is cooled so that the desired properties of the thermoplastic material are achieved.

The hot-melt H1 is injected through the one or more channels 605A, 605B into the mold volume 606. The hot-melt H1 is injected until the waveguide 100 is completely surrounded by the hot-melt H1. The mold protrusion 603 helps cool the hot melt H1 injected by the first grating 104a in order to keep the mirror coat disposed over the first grating 104a from getting damaged. It is contemplated that in one or more embodiments the mirror coat is omitted. In one or more embodiments multiple mold protrusions 603 are located in the mold volume 606 to cool the hot-melt H1 around the desired areas of the waveguide 100.

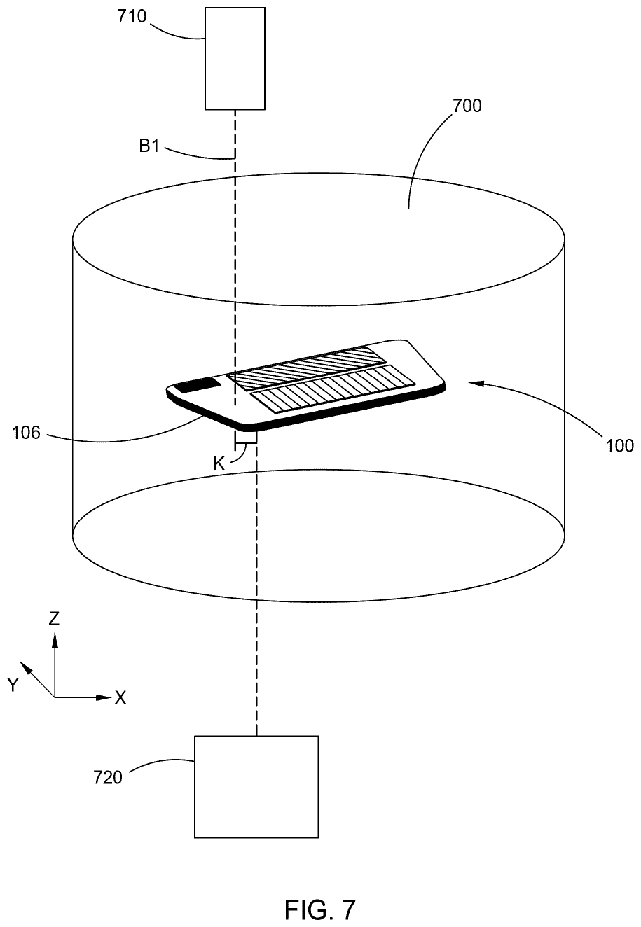

In one or more embodiments, the one or more supports 604 are made of the same thermoplastic material as the material used to form the hot-melt H1. During operation 504 as the hot-melt H1 is injected it surrounds the supports 604. After the hot-melt H1 cools, the supports become part of the thermoplastic block. In one or more embodiments the supports 604 are coupled to the chamber body 601, and the supports 604 have a tapered geometry so that when the hot-melt H1 cools, the thermoplastic block is able to be easily removed from the supports 604. At operation 506 thermoplastic hot-melt H1 is cooled into a solid form to form a thermoplastic block 700 (FIG. 7). Once cooled the thermoplastic block 700 is removed from the chamber by opening the lid 602. At operation 508, as shown in FIG. 7, the position of the waveguide 100 is measured inside the thermoplastic block 700. In one or more embodiments a laser beam B1 is emitted from a laser emitter 710 so that the beam B1 hits a laser receiver 720.

FIG. 7 is a schematic view of a thermoplastic block 700, during a measuring operation 508 of the method 500 shown in FIG. 5, according to one or more embodiments. The beam B1 is emitted through the thermoplastic block 700 from the laser emitter 710 to the laser receiver 720. To determine the position of the waveguide 100 inside the thermoplastic block 700 the thermoplastic block is moved in the X direction until the beam hits an edge 106 of the waveguide 100. In one or more embodiments the edge 106 is blackened so that when the edge 106 contacts the beam B1, the edge 106 absorbs the beam B1 and intercepts the beam B1 from shining through to the laser receiver 720. From this process a user can know the position of the waveguide 100 in the X direction within the thermoplastic block 700. This processed can be repeated by moving the thermoplastic block 700 in the Y direction to determine the position of the waveguide 100 in the thermoplastic block 700 in then Y direction.

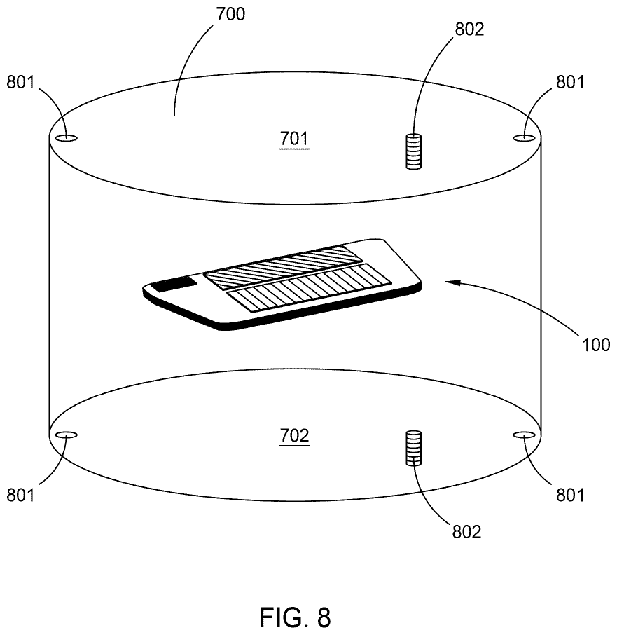

FIG. 8 is a schematic view of the thermoplastic block 700 of FIG. 7 after an engraving operation 510 of the method 500 shown in FIG. 5, according to one or more embodiments. One of more fiducials 801 are engraved into a top surface 701 and a bottom surface 702 of the thermoplastic block 700. A laser engraved code 802 is engraved in both the top surface 701 and bottom surface 702. The laser engraved code 802 includes instructions containing the waveguide coordinates relative to the one or more fiducials 801.

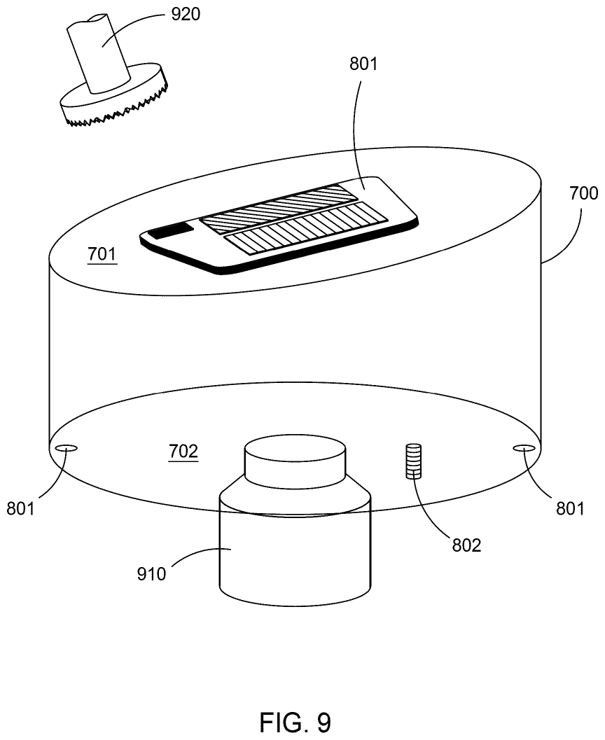

FIG. 9 is a schematic view of the thermoplastic block 700 of FIGS. 7 and 8 during a milling operation 512 of method 500 shown in FIG. 5, according to one or more embodiments. At operation 512 the thermoplastic block 700 around the waveguide 100 is milled down and polished to form a thermoplastic lens.

As shown in FIG. 9, a holder is coupled to the bottom surface 702 of the thermoplastic block 700. A milling tool 920 machines down the top surface 701 of the thermoplastic block according to the instructions of the laser engraved code 802. The milling tool machines down the top surface 701 until the desired shape of the top surface is formed, and the desired distance from the waveguide 100 is reached. The thermoplastic block 700 is then rotated so that the bottom surface 702 can be machined to the desired dimensions by the milling tool 920. After both the top surface 701 and bottom surface 702 are machined to the desired dimensions, the sides of the thermoplastic block 700 are machined down to the desired dimensions so that a thermoplastic lens is formed.

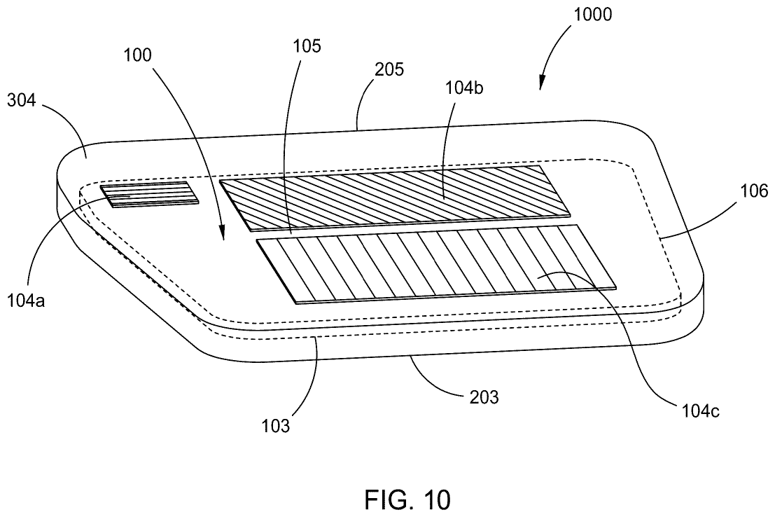

FIG. 10 is a schematic isometric view of an optical device 1000 formed by performing the method 500 shown in FIG. 5, according to one or more embodiments. The optical device 1000 is similar to the optical devices 200, 300, and 400 shown in FIGS. 2, 3, and 4, and includes one or more of the aspects, features, components, properties, and/or operations thereof.

Benefits of the present disclosure include improved alignment of a push-pull lens with a waveguide; decreased contaminates between the lens and the waveguide; decreased risk to damaging the waveguide; increased production efficiency; decreased cost; decreased maintenance; decreased number of parts; and enhanced device performance.

It is contemplated that one or more aspects disclosed herein may be combined. As an example, one or more aspects, features, components, operations, and/or properties of the various embodiments of the waveguide 100; the gratings 104; the one or more edges 106; the first surface 103; the second surface 105; the optical device 200; the thermoplastic lens 201; the first lens surface 203; the second lens surface 205; the optical device 300; the light engine seat 304; the optical device 400; the intermediate layer 401; the method 500; the mold chamber 600; the chamber body 601; the lid 602; the mold protrusion 603; the one or more supports 604; the extruder 650; the thermoplastic hot-melt H1; the thermoplastic block 700; the laser emitter 710; the laser receiver 720; the laser beam B1; the one or more fiducials 801; the laser engraved code 802; the holder 910; the milling tool 920; and/or the optical device 1000 may be combined. Moreover, it is contemplated that one or more aspects disclosed herein may include some or all of the aforementioned benefits.

While the foregoing is directed to embodiments of the present disclosure, other and further embodiments of the disclosure may be devised without departing from the basic scope thereof, and the scope thereof is determined by the claims that follow.

What is claimed is:

1. An optical device comprising:
a waveguide, the waveguide having a first surface and a second surface opposing the first surface, the first surface and the second surface are connected by an edge, wherein one or more gratings are disposed over the first surface or the second surface; and
a thermoplastic lens surrounding the first surface, second surface, and the edge, wherein the thermoplastic lens comprises a first lens surface disposed over the first surface and a second lens surface disposed over the second surface.

2. The optical device of claim 1, wherein the first lens surface is concave, and the second lens surface is convex.

3. The optical device of claim 1, wherein the first lens surface further comprises a light engine seat, the light engine seat comprising a flat surface formed in the first lens surface.

4. The optical device of claim 1, wherein the first lens surface has a negative diopter.

5. The optical device of claim 1, wherein the second lens surface has a positive diopter.

6. The optical device of claim 1, wherein the one or more gratings comprise an incoupler, an outcoupler, and a pupil expander.

7. The optical device of claim 1, further comprising:
an intermediate layer surrounding the first surface, the second surface, and the edge, the thermoplastic lens surrounding the intermediate layer.

8. The optical device of claim 7, wherein the waveguide has a refractive index of about 1.5 to 2.1;
the intermediate layer has the refractive index of about 1.0 to 1.1; and
the thermoplastic lens has the refractive index of about 1.5 to 1.6.

9. The optical device of claim 7, wherein the intermediate layer includes an aerogel material.

10. The optical device of claim 1, wherein the edge coated with black ink.

11. The optical device of claim 1, wherein the thermoplastic lens includes polycarbonate material.

12. A chamber comprising:
a chamber body;
an extruder;
one or more tapered supports, the one or more tapered supports configured to support a waveguide, the waveguide comprising one or more gratings, wherein the tapered supports are configured to contact the waveguide around the gratings; and
an upper channel, configured to be positioned above the waveguide; and
a lower channel configured to be positioned below the waveguide.

13. The chamber of claim 12, further comprising a mold protrusion configured to be positioned beneath one of the gratings of the waveguide.

14. The chamber of claim 12, wherein the chamber body comprises cooling channels.

15. A method of forming an optical device comprising:
forming a thermoplastic block around a waveguide, the waveguide having a first surface and a second surface opposing the first surface, the first surface and the second surface are connected by an edge, wherein one or more gratings are disposed over the first surface or the second surface; and
milling the thermoplastic block to reduce a second lens surface to form a thermoplastic lens, the thermoplastic lens surrounding the first surface, second surface, and the edge.

16. The method of claim 15, further comprising:
engraving fiducials in the thermoplastic block; and
engraving waveguide coordinates relative to fiducials in the thermoplastic block.

17. The method of claim 15, further comprising:
emitting a laser; and
measuring a position of the waveguide in the thermoplastic block by detecting a refraction of the laser.

18. The method of claim 15, wherein forming the thermoplastic block around the waveguide further comprises:
melting a thermoplastic inside an extruder to form a thermoplastic hot melt; and
injecting the thermoplastic hot melt around the waveguide inside of a chamber mold.

19. The method of claim 18, wherein the thermoplastic hot melt comprises polycarbonate.

20. The method of claim 18, wherein the thermoplastic hot melt comprises allyl diglycol carbonate.
